(19) United States
(12) Patent Application Publication
(10) Pub. No.: US 2026/0268156 A1
(43) Pub. Date: Sep. 10, 2026

(54) SYSTEMS AND METHODS FOR CONTINUAL LEARNING FOR MULTIMODAL TEXT GENERATION

(71) Applicant: JPMORGAN CHASE BANK, N.A., New York, NY (US)

(72) Inventors: Jiangtao KONG, Williamsburg, VA (US); Youngwook DO, New York, NY (US); Peijun ZHAO, Cambridge, MA (US); Shaohan HU, Yorktown Heights, NY (US); Richard CHEN, Baldwin Place, NY (US)

(21) Appl. No.: 19/072,699

(22) Filed: Mar. 6, 2025

(51) Int. Cl. G06N 3/096; G06F 40/242; G06N 3/04

(52) U.S. Cl. CPC G06N 3/096; G06F 40/242; G06N 3/04

(57) ABSTRACT

A method may include: initializing an incremental training multimodal model from a pre-trained multimodal model that is trained on a pre-training dataset, wherein the incremental training multimodal model comprises an encoder, an embedding dictionary, a FeDEx Q-Former, a MoQ module, and a LLM; freezing parameters in the encoder and the LLM; receiving input data and ground truth for a new task; encoding the input data into data embeddings; calculating an interference impact metric (IIM); expanding the incremental training multimodal model; training the FeDEx Q-Former and MoQ modules with training data for a new task; updating the embedding dictionary with the input data using sparse dictionary learning; saving the trained FeDEx Q-Former and MoQ for the new task, and extracted information of the FeDEx Q-Former; and repeating the process for a second new task.

### BACKGROUND OF THE INVENTION

### 1. Field of the Invention

Embodiments are generally directed to systems and methods for continual learning for multimodal text generation.

### 2. Description of the Related Art

Multimodal models are often trained to learn to generate text based on one or more input modalities, including visual, audio, etc. While learning the new knowledge, however, saving the previous original training data poses large memory costs and data privacy issues. As a result, multimodal models are typically trained only on new data, leading to a phenomenon called catastrophic forgetting, where the model excels at generating text for new data but struggles with previous data.

### SUMMARY OF THE INVENTION

Systems and methods for continual learning for multimodal text generation are disclosed. According to an embodiment, a method may include: initializing, by a computer program, an incremental training multimodal model from a pre-trained multimodal model that is trained on a pre-training dataset comprising multimodal data comprising visual or visual and audio data, text instructions, and ground truths for pre-training multimodal data, wherein the incremental training multimodal model comprises an encoder, an embedding dictionary, a Fisher Dynamic Expand (FeDEx) Q-Former, a Mixture of Query (MoQ) module, and a large language model (LLM); freezing, by the computer program, a plurality of parameters in the encoder and the LLM; receiving, by the computer program, input data and ground truth for a new task; encoding, by the computer program, the input data into data embeddings; calculating, by the computer program, an interference impact metric (IIM); expanding, by the computer program, the incremental training multimodal model; training, by the computer program, the FeDEx Q-Former and MoQ modules in the incremental training multimodal model with training data for a new task; updating, by the computer program, the embedding dictionary with the input data using sparse dictionary learning; saving, by the computer program, the trained FeDEx Q-Former and MoQ for the new task, and extracted information of the FeDEx Q-Former; and repeating, by the computer program, the steps of receiving, encoding, calculating, expanding, training, updating, and saving for a second new task.

In one embodiment, the extracted information of the FeDEx Q-Former includes diagonal elements of a Fisher Information Matrix (FIM) and a first order gradient of the trainable parallel adapter in FeDEx Q-Former, and the IIM is calculated based on the diagonal elements of the FIM and the first order gradient.

In one embodiment, the input data further comprises text instructions and ground truths for multimodal data for the new task.

In one embodiment, the data embeddings of the input data are output by the encoder.

In one embodiment, expanding the incremental training multimodal model comprises expanding the MoQ module.

In one embodiment, expanding the MoQ module comprises: freezing, by the computer program, the MoQ module; and adding, by the computer program, a pair of trainable key and query to the MoQ module.

In one embodiment, expanding the incremental training multimodal model further comprises expanding the FeDEx Q-Former in response to the IIM exceeding a pre-defined threshold.

In one embodiment, expanding the FeDEx Q-Former comprises: freezing, by the computer program, the one or more parallel adapters in FeDEx Q-Former; and adding, by the computer program, a trainable parallel adapter to the FedEx Q-Former.

In one embodiment, training the incremental training multimodal model with the training data comprises: organizing, by computer program, the training data for the new task into batches; encoding, by the computer program, one of the batches of training data into data embeddings; calculating, by the computer program, query embeddings based on pre-trained queries and data embeddings, using MoQ and FeDEx Q-Former modules; and updating, by the computer program and using loss back-propagation, the FeDEx Q-Former and the MoQ module in the incremental training multimodal model with a total loss that is a combination of a text generation loss, a dictionary replay loss, and a MoQ loss.

In one embodiment, the text generation loss is based on words generated by the LLM for the query embeddings and ground truths for the input data; the dictionary replay loss is based on a difference between a previous query dictionary and a current query dictionary, where the previous query dictionary is generated using the embedding dictionary with a previous FeDEx Q-Former and a previous MoQ module, and the current query dictionary is generated with the embedding dictionary with a current FeDEx Q-Former and a current MoQ module; and the MoQ loss is based on current weights in the MoQ module.

According to another embodiment, a non-transitory computer readable storage medium may include instructions stored thereon, which when read and executed by one or more computer processors, cause the one or more computer processors to perform steps comprising: initializing an incremental training multimodal model from a pre-trained multimodal model that is trained on a pre-training dataset comprising multimodal data comprising visual or visual and audio data, text instructions, and ground truths for pre-training multimodal data, wherein the incremental training multimodal model comprises an encoder, an embedding dictionary, a Fisher Dynamic Expand (FeDEx) Q-Former, a Mixture of Query (MoQ) module, and a large language model (LLM); freezing a plurality of parameters in the encoder and the LLM; receiving input data and ground truth for a new task; encoding the input data into data embeddings; calculating an interference impact metric (IIM); expanding the incremental training multimodal model; training the FeDEx Q-Former and MoQ modules in the incremental training multimodal model with training data for a new task; updating the embedding dictionary with the input data using sparse dictionary learning; saving the trained FeDEx Q-Former and MoQ for the new task, and extracted information of the FeDEx Q-Former; and repeating the steps of receiving, encoding, calculating, expanding, training, updating, and saving for a second new task.

In one embodiment, the extracted information of the FeDEx Q-Former includes diagonal elements of a Fisher Information Matrix (FIM) and a first order gradient of the trainable parallel adapter in FeDEx Q-Former, and the IIM is calculated based on the diagonal elements of the FIM and the first order gradient.

In one embodiment, the input data further comprises text instructions and ground truths for multimodal data for the new task.

In one embodiment, the data embeddings of the input data are output by the encoder.

In one embodiment, expanding the incremental training multimodal model comprises expanding the MoQ module.

In one embodiment, expanding the MoQ module comprises: freezing the MoQ module; and adding a pair of trainable key and query to the MoQ module.

In one embodiment, expanding the incremental training multimodal model further comprises expanding the FeDEx Q-Former in response to the IIM exceeding a pre-defined threshold.

In one embodiment, expanding the FeDEx Q-Former comprises: freezing the one or more parallel adapters in FeDEx Q-Former; and adding a trainable parallel adapter to the FedEx Q-Former.

In one embodiment, training the incremental training multimodal model with the training data comprises: organizing the training data for the new task into batches; encoding one of the batches of training data into data embeddings; calculating query embeddings based on pre-trained queries and data embeddings, using MoQ and FeDEx Q-Former modules; and updating, using loss back-propagation, the FeDEx Q-Former and the MoQ module in the incremental training multimodal model with a total loss that is a combination of a text generation loss, a dictionary replay loss, and a MoQ loss.

In one embodiment, the text generation loss is based on words generated by the LLM for the query embeddings and ground truths for the input data; the dictionary replay loss is based on a difference between a previous query dictionary and a current query dictionary, where the previous query dictionary is generated using the embedding dictionary with a previous FeDEx Q-Former and a previous MoQ module, and the current query dictionary is generated with the embedding dictionary with a current FeDEx Q-Former and a current MoQ module; and the MoQ loss is based on current weights in the MoQ module.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for continual learning for multimodal text generation according to an embodiment;

FIGS. 2A and 2B illustrate a method for continual learning for multimodal text generation according to an embodiment;

FIG. 3 depicts a method for module expansion according to an embodiment;

FIG. 4 depicts a method for dictionary replay according to an embodiment; and

FIG. 5 depicts an exemplary computing system for implementing aspects of the present disclosure.

### DETAILED DESCRIPTION OF PREFERRED EMBODIMENTS

Systems and methods for continual learning for multimodal text generation are disclosed. Embodiments may enable a multimodal model to learn to generate text for different modalities, such as image, video, video with audio, etc., components as untrained types of visual objects and other types of modalities are introduced sequentially, while mitigating “forgetting” without accessing previous original training data.

Embodiments may provide a continual learning framework for multimodal text generation based on large pre-trained model. Embodiments may be initialized by a multimodal model, such as Bootstrapping Language-Image Pre-training with Frozen Image Encoders and Large Language Models (“BLIP-2”) to continually align pre-trained large visual, audio, or visual and audio models, and language models. The multimodal model may generate coherent and contextually relevant text, such as descriptions of the multimodal inputs, or the answer of questions about the multimodal inputs, by leveraging pre-trained language models.

Embodiments may mitigate catastrophic forgetting more effectively by focusing on cross-modality alignment on both new and previously-learned data; may dynamically expand adapters for the model based on measuring the interference of new task learning on the performance of previous tasks; may learn and mixture the task-special query for different task without selection function.

Embodiments may use a dictionary replay to mitigate the catastrophic forgetting in multimodal text generation continual learning.

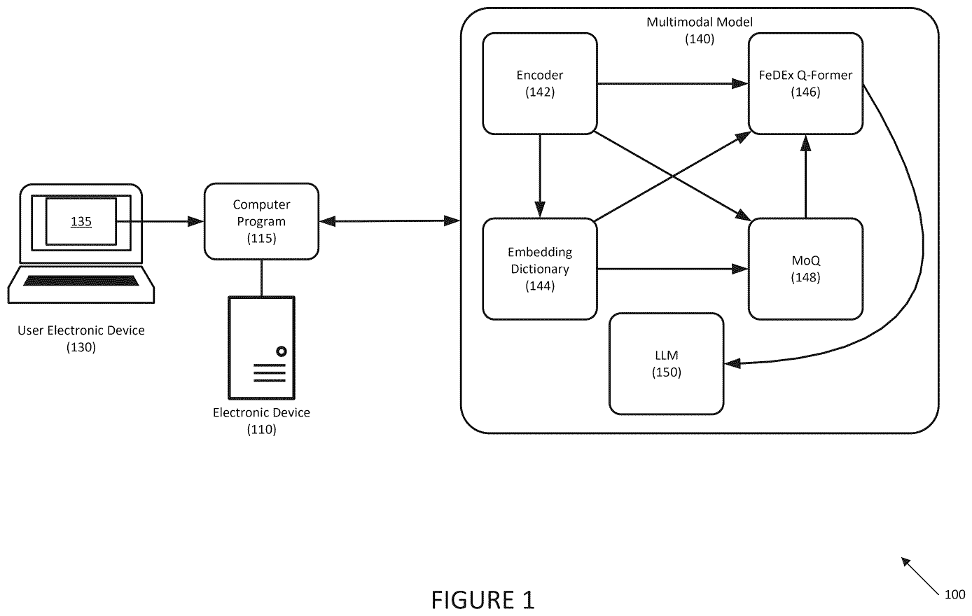

Referring to FIG. 1, a system for continual learning for multimodal text generation is disclosed according to an embodiment. System 100 may include electronic device 110, which may be a server (e.g., physical and/or cloud-based), a computer (e.g., a workstation, a desktop, a laptop, a notebook, a tablet, etc.), etc. Electronic device 110 may execute computer program 115, such as a continual learning computer program.

Computer program 115 may evaluate text generated by multimodal model 140. In FIG. 1, only one multimodal model 140 is illustrated; it should be recognized that multiple multimodal models 140 may be provided, including multimodal models 140 executed over a computer network.

Computer program 115 may control the training and inference process of multimodal model 140.

Multimodal model 140 may include a plurality of modules, including encoder 142, embedding dictionary 144, Fisher Dynamic Expand Querying Transformer (“FeDEx Q-Former”) 146, Mixture of Query (“MoQ”) module 148, and large language model (LLM) 150. Multimodal model 140 may receive, as an input, image, video, or video and audio, as well as text instruction, from computer program 115.

Encoder 142 may process data, such as images, video and video/audio data, to extract embeddings for the data.

Embedding dictionary 144 may use sparse dictionary learning to update its elements using the embeddings extracted by encoder 142. Sparse dictionary learning is a type of machine learning technique that may be used to find a sparse representation of input data. The goal is to represent input data as a linear combination of a few elements from a dictionary, which is a set of basis vectors.

FeDEx Q-Former 146 may be a neural network module that focuses on important parts of multimodal input, such as images, audios, etc. In embodiments, queries are the starting point that help FeDEx Q-Former 146 identify and understand important details in an image. A FeDEx Q-Former is designed for continual learning as it can dynamically expand the network architecture by detecting that the current network structure can learn the knowledge without influencing the previous knowledge.

FeDEx Q-Former 146 may be based on a transformer-based network, such as that described in He et al., “Towards A Unified View Of Parameter-Efficient Transfer Learning” (available at arXiv:2110.04366v3), the disclosure of which is hereby incorporated, by reference, in its entirety, and may include one or more parallel adapters that may be parallelly added to the pre-trained model. The parallel adapters may be added to each attention and feedforward neural network layer within the transformer-based network.

MoQ module 148 may execute an algorithm that mixes the new queries for the new task with the set of queries from the previous tasks as input queries to FeDEx Q-Former 146.

System 100 may further include user electronic device 130, which may be a computer, a smart device (e.g., smartphone, smart watch, etc.), an Internet of Things appliance, etc. User electronic device 130 may execute user computer program 135, which may receive and output the results of the analysis by computer program 115.

User computer program 135 may also issue prompts to multimodal model 140.

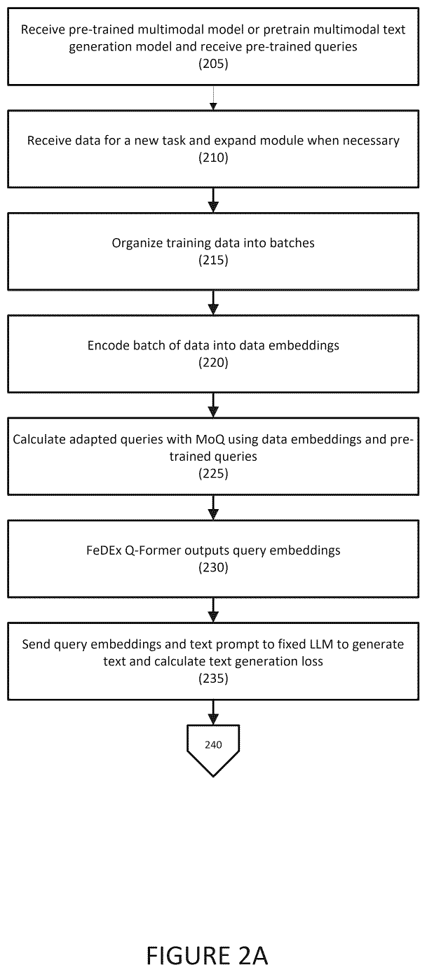

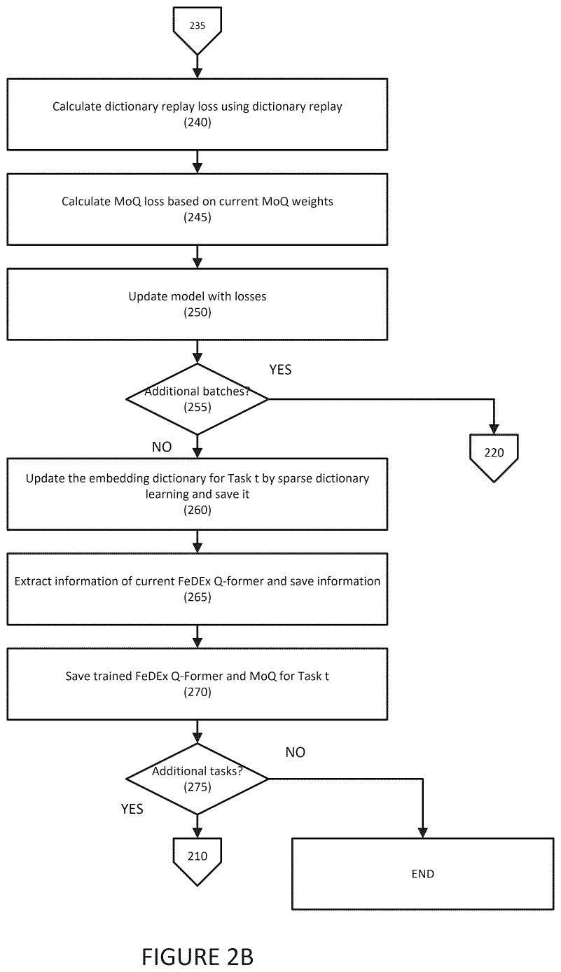

Referring to FIGS. 2A and 2B, a method for continual learning for multimodal text generation is disclosed according to an embodiment.

In step 205, a computer program executed by an electronic device may receive a pre-trained BLIP-2 style multimodal model that may be trained on a large multimodal pre-training dataset, such as visual or visual and audio data, with or without text instructions. For example, the model can be pre-trained on datasets include images and the captions of images, or on datasets include videos (with or without audio) and captions of videos.

The computer program may use the pre-trained multimodal model to initialize an incremental training multimodal model that may include an encoder, an embedding dictionary, a FeDEx Q-Former, a MoQ module, and an LLM. The Encoder and LLM weights should be frozen.

The computer program may also receive pre-trained queries. The pre-trained queries may be provided by the pre-trained BLIP-2 style model. The pre-trained BLIP-2 style model may be trained on, for example, an open-source dataset, or by any other dataset as is necessary and/or desired.

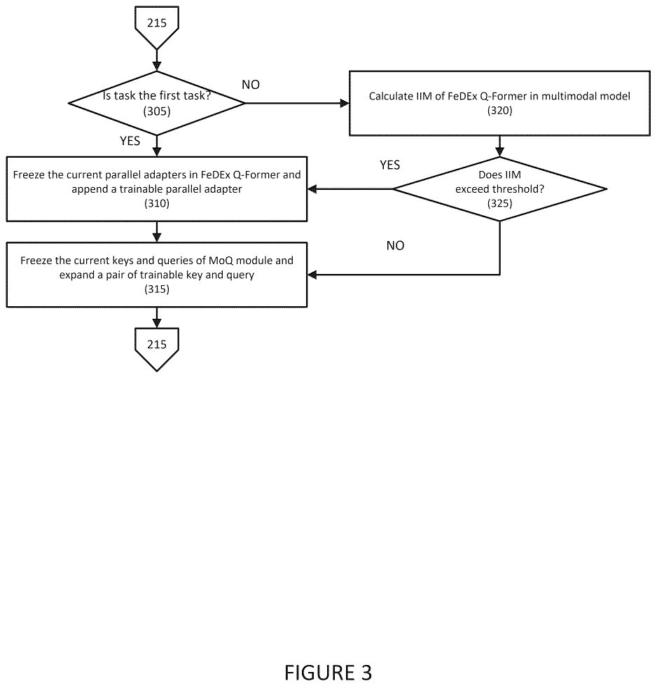

In step 210, after receiving the instruction to learn a new task, when necessary, the computer program may expand the incremental training multimodal model based on the data received of the new task. This is described with reference to FIG. 3.

In step 305, a check is made to see if the new task t is the first task. If it is, in step 310, the computer program may freeze the current parallel adapters in FeDEx Q-Former, and append a trainable parallel adapter on the FeDEx Q-Former to learn task t. Thus, the parameters, or network weights, for the parallel adapters are not updated in further training when they are frozen.

An example parallel adapter is described in He et al., “Towards A Unified View of Parameter-Efficient Transfer Learning” (available at arXiv:2110.04366v3), the disclosure of which is hereby incorporated, by reference, in its entirety.

Next, in step 315, the computer program may freeze the weights of trained lists of keys and queries of the MoQ module, and may expand a pair of trainable key and query to learn task t.

For instance, if the computer program is currently training for task 5, there are 4 trained key vectors and 4 trained query vectors. These trained keys and queries are frozen, and a new trainable key vector and a new trainable query vector are added, resulting in 5 key vectors and 5 query vectors: 4 of each are frozen, and 1 of each is trainable.

The process may then return to step 215.

If the task is not the first task, in step 320, the computer program may receive images, videos, or video and audio for the new task, and may compute an Interference Impact Metric (IIM), which may be based on diagonal elements in the Fisher Information Matrix (FIM) of the FeDEx Q-Former and the first order gradient of the trainable parallel adapter. The IIM may reflect the overall conflict between parameter updates for the new task and the preservation of prior knowledge.

The FIM measures the amount of information an observable random variable carries about an unknown parameter on which the probability depends. The diagonal elements in the FIM may be used to assess the sensitivity of parameters with respect to changes in the input data. An example FIM is described in Fisher R. A., “On the mathematical foundations of theoretical statistics”, Philosophical Transactions of the Royal Society of London, Series A. 222 (594-604): 309-368 (1922), the disclosure of which is hereby incorporated, by reference, in its entirety.

The FIM may be calculated using the gradient of parameters of the trainable parallel adapter of the FeDEx Q-Former. The gradient calculation is based on back-propagation of the loss calculated with current task data. The loss may be calculated by inputting the multimodal input (images, audios, videos, etc.) data and the ground truth text. The ground truth text may be an accepted description of an image, audio, video, or the answer to the questions about an image, audio, video, etc. The loss calculation method is the same as described in step 235, step 240 and step 245.

In one embodiment, the computer program may calculate the IIM, S(ωₜ), as follows:

$$I ( {ω}_{t , i} ) = - {∇}_{{ω}_{i}} {L}_{{𝒟}_{t}} ( {ω}_{t} ) {∇}_{{ω}_{i}} {L}_{{𝒟}_{t + 1}} ( {ω}_{t} ) + \frac{1}{2} {F}_{{𝒟}_{t}}^{i} ( {ω}_{r} ) {( {∇}_{{ω}_{i}} {L}_{{𝒟}_{t + 1}} ( {ω}_{t} ) )}^{2}$$

$${I}_{-} ( {ω}_{t} ) = {\sum }_{i = 1}^{N} max \{ 0 , - I ( {ω}_{t , i} ) \}$$

$${I}_{+} ( {ω}_{t} ) = {\sum }_{i = 1}^{N} max \{ 0 , I ( {ω}_{t , i} ) \}$$

$$S ( {ω}_{t} ) = \frac{{I}_{+} ( {ω}_{t} )}{{I}_{+} ( {ω}_{t} ) + {I}_{-} ( {ω}_{t} )}$$

where ωₜ is the model parameters trained by task t. [symbol] ₜ and [symbol] ₜ₊₁ are denoted as dataset of task t and task t+1, respectively. ∇_{ω}_{ₜ} [symbol] (ωₜ) means the gradient calculated by back-propagation of the loss on ωₜ and [symbol] t, and ∇_{ω}_{ᵢ} [symbol] (ωₜ) means the gradient calculated by back-propagation of the loss on ωₜ and [symbol] ₜ₊₁.

$${F}_{{𝒟}_{t}}^{i} ( {ω}_{t} )$$

represent the i-the diagonal element of Fisher Information Matrix, and the IIM, S(ωₜ), is the final metric calculation. The value IIM belongs to [0,1].

If, in step 325, the IIM exceeds a pre-defined threshold, which indicates that the parameters influence both tasks, the process may return to step 310.

In one embodiment, the threshold may be set by the user.

If not, the process may continue to step 315.

Referring to FIG. 2A, in step 215, the computer program may organize the training data for the new task into batches.

In step 220, the computer program may encode a batch of data into data embeddings. For example, the original data (e.g., image, video, audio, etc.) is provided to the encoder, which outputs the data embedding. The data embedding is the lower-dimensional vector representation of the original input data.

In step 225, the computer program may calculate adapted queries with the MoQ module using data embeddings and pre-trained queries. The MoQ module may develop specific queries for each task to acquire new information, while also combining queries from previous tasks to minimize forgetting.

An attention mechanism may be used to calculate the adapted queries as follows: adapted queries=pre-trained queries+Attention(data embeddings, keys, queries). Attention is a mechanism in neural networks designed to dynamically focus on and prioritize certain parts of the input data, enabling the model to weigh the importance of different elements when making predictions or generating outputs. By incorporating attention, the incremental training multimodal model may selectively attend to and process the most relevant information, capturing dependencies and relationships within the data.

The data embedding and keys from different tasks may be used to calculate the weight for each task. The weights may then be multiplied by the corresponding task queries and combined to include queries from previous tasks.

The combined queries may be added to the pre-trained queries to obtain the adapted queries.

In step 230, the computer program may generate query embeddings based on the data embeddings and the adapted queries via the FeDEx Q-Former.

For example, the FeDEx Q-Former may receive data embeddings and adapted queries from the MoQ module. The Q-Former may then use self-attention and cross-attention mechanism so that the adapted queries capture the important information from data embeddings, and may then output the query embeddings.

In step 235, the computer program may pass the query embeddings to the LLM with a decoder to generate words, with or without a text instruction, and may then calculate a text generation loss. The text generation loss may be calculated by comparing the generated text with the given ground truth texts. In one embodiment, the computer program may calculate the cross-entropy loss of the ground truth text and generated text. The ground truth text may come from the dataset, such as captions of images or videos, or questions and answers about the images or videos.

In step 240, the computer program may perform dictionary replay to calculate dictionary replay loss. Dictionary replay is replaying the dictionary of input data representations in order to maintain the network's performance on previous tasks. This may enhance the incremental training multimodal model's stability and mitigating catastrophic forgetting.

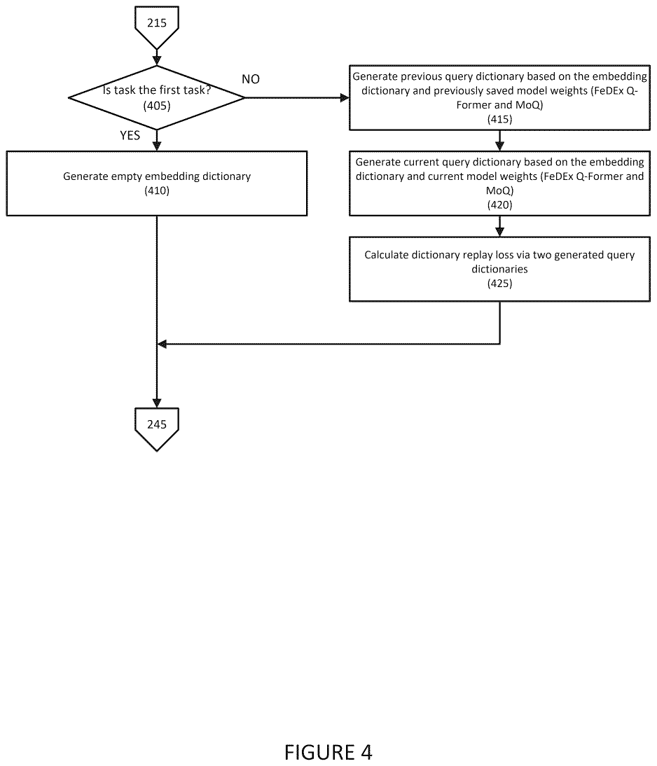

An example of a method of dictionary replay is provided in FIG. 4.

In step 405, a check is made to see if the task t is the first task. If it is, in step 410, the computer program may generate an empty embedding dictionary, such as a list of empty embeddings. For example, the embedding dictionary may be an over-complete dictionary. Over-complete dictionary refers to a set of basis vectors (or atoms) that is larger than the dimension of the signals being represented. For example, the shape of one vector (or atom) in over-complete dictionary may be [1*768], the shape of an over-complete may be [A*768], which means the dictionary has A vectors (or atoms), and A is much larger than 768, such as 7680.

If task t is first task, dictionary replay loss will be set to 0.

The process may then return to step 245.

If the task is not the first task, in step 415, the computer program may receive the embedding dictionary and the pre-trained queries, and the embedding dictionary may be input into the previously saved FeDEx Q-Former and MoQ module, along with the pre-trained queries into the previously saved MoQ module, following steps 225 and 230. This process generates previous query dictionary for the embedding dictionary.

In step 420, the computer program may generate a second query dictionary-a current query dictionary—with the embedding dictionary and pre-trained queries via the current MoQ module and FeDEx Q-Former, being trained by the current dataset. This may be similar to step 415, above.

In step 425, the computer program may calculate the dictionary replay loss by comparing the previous query dictionary to the current query dictionary. In one embodiment, the computer program may calculate the Mean-Squared Error (MSE) between all pairs of query embeddings in previous and current query dictionary.

The process may then return to step 245.

Referring again to FIG. 2B, in step 245, the computer program may calculate a MoQ loss based on current MoQ weights. In one embodiment, the MoQ loss may be calculated as follows:

$${ℒ}_{orth} ( {k}_{t} , {v}_{t} ) = {‖ {v}_{t} {v}_{< t}^{T} ‖}_{F}^{2} + {‖ {k}_{t} {k}_{< t}^{T} ‖}_{F}^{2}$$

$${ℒ}_{key} ( {k}_{t} ) = \frac{1}{\vert {𝒟}_{t} \vert} {\sum }_{i = 1}^{\vert {𝒟}_{t} \vert} ( 1 - \frac{\overline{{e}_{t , ι}}}{{‖ \overline{{e}_{t , ι}} ‖}_{2}} \cdot \frac{{k}_{t}}{{‖ {k}_{t} ‖}_{2}} )$$

$${ℒ}_{MoQ} = {ℒ}_{orth} + {ℒ}_{key}$$

where kₜ, vₜ means the expanded key and query for the task t, k_{<t}, v_{<t} means the trained key and query in the MoQ module. For example, if in the task 5, then k_{<t}, v_{<t} means the key and query from task 1 to task 4, and kₜ, vₜ means the key and query for task 5. | [symbol] ₜ| means the sample number of dataset [symbol] ₜ, and e̅_̅{̅t̅,̅l̅}̅ means the average of the image patch embedding of each image. The function of [symbol] ₒᵣₜₕ(kₜ, vₜ) is to decrease the interference across tasks, and make sure that the newly learned embeddings are irrelevant to those from previous tasks. Furthermore, the term [symbol] _{key}(kₜ) aims to ensure that each task-specific key kₜ is relevant to visual embeddings in task t.

In step 250, the computer program may update the incremental training multimodal model with the losses from step 235, step 240, and step 245. For example, the computer program may calculate a total loss by adding the three losses with a certain weight combination, and perform loss back-propagation to calculate gradient and update the weights of the FeDEx Q-Former and MoQ modules. In one embodiment, the weight combination can be empirically assigned by the user.

In another embodiment, the model parameter update can be performed by an optimizer, such as SGD, Adam, etc. The model training can be done using a framework, for example, PyTorch or TensorFlow.

In step 255, if there are additional batches for the new task, the process may return to step 220.

In step 260, the computer program may update the embedding dictionary for task t by sparse dictionary learning, and may save the embedding dictionary. An example of sparse dictionary learning is disclosed in Mairal, J. et al, “Online Learning for Matrix Factorization and Sparse Coding” (2009) the disclosure of which is hereby incorporated, by reference, in its entirety. For example, the computer program may modify the values in the embedding dictionary to improve its effectiveness. The goal of sparse dictionary learning is to update the embedding dictionary so that it can be used to reconstruct the embeddings of previously trained data using sparse coding. Typically, only a few vectors (or atoms) from the dictionary are needed to reconstruct each embedding.

In step 265, the computer program may extract information about the current FeDEx Q-Former in the incremental training multimodal model for task t and may save the extracted information. In one embodiment, the computer program may extract the diagonal elements of the Fisher Information Matrix (FIM) and the first order gradient of the current trainable Parallel Adapter in FeDEx Q-Former.

In step 270, the computer program may save the trained FeDEx Q-Former and MoQ module for task t.

In step 275, if there are additional tasks (i.e., task t+1), the process may return to step 210.

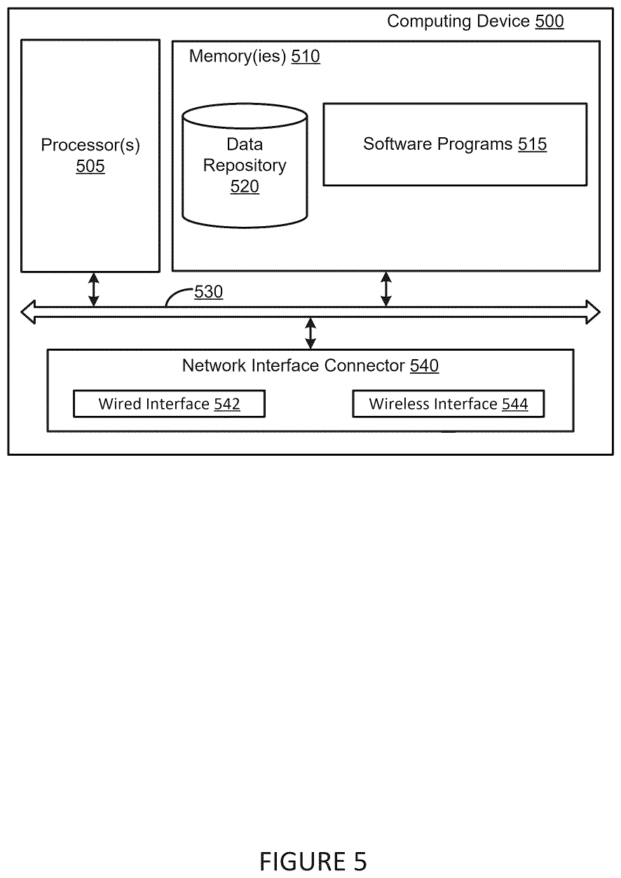

FIG. 5 depicts an exemplary computing system for implementing aspects of the present disclosure. FIG. 5 depicts exemplary computing device 500. Computing device 500 may represent the system components described herein. Computing device 500 may include processor 505 that may be coupled to memory 510. Memory 510 may include volatile memory. Processor 505 may execute computer-executable program code stored in memory 510, such as software programs 515. Software programs 515 may include one or more of the logical steps disclosed herein as a programmatic instruction, which may be executed by processor 505. Memory 510 may also include data repository 520, which may be nonvolatile memory for data persistence. Processor 505 and memory 510 may be coupled by bus 530. Bus 530 may also be coupled to one or more network interface connectors 540, such as wired network interface 542 or wireless network interface 544. Computing device 500 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity, i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
initializing, by a computer program, an incremental training multimodal model from a pre-trained multimodal model that is trained on a pre-training dataset comprising multimodal data comprising visual or visual and audio data, text instructions, and ground truths for pre-training multimodal data, wherein the incremental training multimodal model comprises an encoder, an embedding dictionary, a Fisher Dynamic Expand (FeDEx) Q-Former, a Mixture of Query (MoQ) module, and a large language model (LLM);
freezing, by the computer program, a plurality of parameters in the encoder and the LLM;
receiving, by the computer program, input data and ground truth for a new task;
encoding, by the computer program, the input data into data embeddings;
calculating, by the computer program, an interference impact metric (IIM);
expanding, by the computer program, the incremental training multimodal model;
training, by the computer program, the FeDEx Q-Former and MoQ modules in the incremental training multimodal model with training data for a new task;
updating, by the computer program, the embedding dictionary with the input data using sparse dictionary learning;
saving, by the computer program, the trained FeDEx Q-Former and MoQ for the new task, and extracted information of the FeDEx Q-Former; and
repeating, by the computer program, the steps of receiving, encoding, calculating, expanding, training, updating, and saving for a second new task.

2. The method of claim 1, wherein the extracted information of the FeDEx Q-Former includes diagonal elements of a Fisher Information Matrix (FIM) and a first order gradient of a trainable parallel adapter in FeDEx Q-Former, and the IIM is calculated based on the diagonal elements of the FIM and the first order gradient.

3. The method of claim 1, wherein the input data further comprises text instructions and ground truths for multimodal data for the new task.

4. The method of claim 1, wherein the data embeddings of the input data are output by the encoder.

5. The method of claim 1, wherein expanding the incremental training multimodal model comprises expanding the MoQ module.

6. The method of claim 5, wherein expanding the MoQ module comprises:
freezing, by the computer program, the MoQ module; and
adding, by the computer program, a pair of trainable key and query to the MoQ module.

7. The method of claim 1, wherein expanding the incremental training multimodal model further comprises expanding the FeDEx Q-Former in response to the IIM exceeding a pre-defined threshold.

8. The method of claim 7, wherein expanding the FeDEx Q-Former comprises:
freezing, by the computer program, one or more parallel adapters in FeDEx Q-Former; and
adding, by the computer program, a trainable parallel adapter to the FedEx Q-Former.

9. The method of claim 1, wherein training the incremental training multimodal model with the training data comprises:
organizing, by computer program, the training data for the new task into batches;
encoding, by the computer program, one of the batches of training data into data embeddings;
calculating, by the computer program, query embeddings based on pre-trained queries and data embeddings, using MoQ and FeDEx Q-Former modules; and
updating, by the computer program and using loss back-propagation, the FeDEx Q-Former and the MoQ module in the incremental training multimodal model with a total loss that is a combination of a text generation loss, a dictionary replay loss, and a MoQ loss.

10. The method of claim 9, wherein the text generation loss is based on words generated by the LLM for the query embeddings and ground truths for the input data;
the dictionary replay loss is based on a difference between a previous query dictionary and a current query dictionary, where the previous query dictionary is generated using the embedding dictionary with a previous FeDEx Q-Former and a previous MoQ module, and the current query dictionary is generated with the embedding dictionary with a current FeDEx Q-Former and a current MoQ module; and
the MoQ loss is based on current weights in the MoQ module.

11. A non-transitory computer readable storage medium, including instructions stored thereon, which when read and executed by one or more computer processors, cause the one or more computer processors to perform steps comprising:
initializing an incremental training multimodal model from a pre-trained multimodal model that is trained on a pre-training dataset comprising multimodal data comprising visual or visual and audio data, text instructions, and ground truths for pre-training multimodal data, wherein the incremental training multimodal model comprises an encoder, an embedding dictionary, a Fisher Dynamic Expand (FeDEx) Q-Former, a Mixture of Query (MoQ) module, and a large language model (LLM);
freezing a plurality of parameters in the encoder and the LLM;
receiving input data and ground truth for a new task;
encoding the input data into data embeddings;
calculating an interference impact metric (IIM);
expanding the incremental training multimodal model;
training the FeDEx Q-Former and MoQ modules in the incremental training multimodal model with training data for a new task;
updating the embedding dictionary with the input data using sparse dictionary learning;
saving the trained FeDEx Q-Former and MoQ for the new task, and extracted information of the FeDEx Q-Former; and
repeating the steps of receiving, encoding, calculating, expanding, training, updating, and saving for a second new task.

12. The non-transitory computer readable storage medium of claim 11, wherein the extracted information of the FeDEx Q-Former includes diagonal elements of a Fisher Information Matrix (FIM) and a first order gradient of a trainable parallel adapter in FeDEx Q-Former, and the IIM is calculated based on the diagonal elements of the FIM and the first order gradient.

13. The non-transitory computer readable storage medium of claim 11, wherein the input data further comprises text instructions and ground truths for multimodal data for the new task.

14. The non-transitory computer readable storage medium of claim 11, wherein the data embeddings of the input data are output by the encoder.

15. The non-transitory computer readable storage medium of claim 11, wherein expanding the incremental training multimodal model comprises expanding the MoQ module.

16. The non-transitory computer readable storage medium of claim 15, wherein expanding the MoQ module comprises:
freezing the MoQ module; and
adding a pair of trainable key and query to the MoQ module.

17. The non-transitory computer readable storage medium of claim 11, wherein expanding the incremental training multimodal model further comprises expanding the FeDEx Q-Former in response to the IIM exceeding a pre-defined threshold.

18. The non-transitory computer readable storage medium of claim 17, wherein expanding the FeDEx Q-Former comprises:
freezing one or more parallel adapters in FeDEx Q-Former; and
adding a trainable parallel adapter to the FedEx Q-Former.

19. The non-transitory computer readable storage medium of claim 11, wherein training the incremental training multimodal model with the training data comprises:
organizing the training data for the new task into batches;
encoding one of the batches of training data into data embeddings;
calculating query embeddings based on pre-trained queries and data embeddings, using MoQ and FeDEx Q-Former modules; and
updating, using loss back-propagation, the FeDEx Q-Former and the MoQ module in the incremental training multimodal model with a total loss that is a combination of a text generation loss, a dictionary replay loss, and a MoQ loss.

20. The non-transitory computer readable storage medium of claim 19, wherein the text generation loss is based on words generated by the LLM for the query embeddings and ground truths for the input data;
the dictionary replay loss is based on a difference between a previous query dictionary and a current query dictionary, where the previous query dictionary is generated using the embedding dictionary with a previous FeDEx Q-Former and a previous MoQ module, and the current query dictionary is generated with the embedding dictionary with a current FeDEx Q-Former and a current MoQ module; and
the MoQ loss is based on current weights in the MoQ module.
